(19) United States
(12) Patent Application Publication
(10) Pub. No.: US 2019/0161335 A1
(43) Pub. Date: May 30, 2019

(54) DEVICE FOR POURING BEER WITH A HIGH CARBON DIOXIDE CONTENT

(71) Applicant: DUVEL MOORTGAT NV, Puurs (BE)

(72) Inventors: Hedwig NEVEN, Goetsenhoven (BE); Michel MOORTGAT, Sint-Martens-Latem (BE)

(21) Appl. No.: 16/313,278

(22) PCT Filed: Jun. 30, 2017
(86) PCT No.: PCT/IB2017/000807

§ 371 Date: Dec. 26, 2018

(30) Foreign Application Priority Data
Jul. 1, 2016 (BE) BE2016/5551

(51) Int. Cl. B67D 1/04; B67D 1/06; B67D 1/08

(52) U.S. Cl. CPC B67D 1/0406; B67D 1/06; B67D 2210/00139; B67D 2210/00047; B67D 1/08

(57) ABSTRACT

The present invention relates to a device for the dispensing of a drink containing carbon dioxide, such as beer, from a barrel (2), the device comprising: •—a tapping line (3) which at a first end is connectable to the barrel (2) containing the drink, wherein a fluidic connection is created between the drink in the barrel (2) and the tapping line (3): •—a pressure line (10), also connectable to the barrel (2) and connected to a source or compressed air or gas (9); •—a cooling compartment (8) for one or more barrels (2); •—a tap tower (5) provided with a faucet (6) wherein the tap tower (5) has an internal channel for receiving part of the tapping line (3), including the second end, the length of the tapping line (3) is between 1.8 and 2.4 m and it has an internal diameter of between 2.5 and 3.5 mm.

### TECHNICAL DOMAIN

The invention relates to a tapping device for pouring draught beer, wherein the beer has been refermented in the barrel and consequently has a high CO₂ content.

### PRIOR ART

Many beer-lovers prefer draught beer to bottled beer. Beer from the barrel is generally considered to be of higher quality in terms of taste. In addition draught beer also retains its quality and flavour as it is not exposed to light. For these reasons draught beer is often preferred.

Hitherto it has not been possible to provide draught beer with a high carbon dioxide (CO₂) content, obtained through refermentation. Among other things, problems with excessive foaming mean that such beers cannot be poured in a quality manner. To date breweries have solved this problem by offering the consumer two types of beer: beer refermented in the bottle with a high CO₂ content and an identical draught beer, which, however, has not been refermented and consequently has a lower CO₂ content. It goes without saying that this results in a difference in taste.

However, from a technical point of view there is no tapping device from the prior art which is able to pour beer refermented in the barrel with a high CO₂ in a quality manner.

EP 1 255 689 describes a tapping device for beer provided with means for automatic application of externally supplied carbon dioxide into beer. This additional carbon dioxide serves to force the beer out of the barrel and to maintain the equilibrium pressure in the beer. However, EP 1 255 689 does not relate to beer that is refermented in the barrel and thus inherently has a high natural CO₂ content.

EP 2 562 129 discloses a device for dispensing a drink containing carbon dioxide, such as beer, from a barrel. Nevertheless EP 2 562 129 lacks a solution for dispensing a drink with a high carbon dioxide content, such as beer refermented in the barrel.

In EP 0 114 202 a spool-type valve for use in a device for dispensing carbonated water is described. However EP 0 114 202 does not provide a solution for dispensing a drink with a high carbon dioxide content, such a beer refermented in the barrel, in a quality manner.

WO 2008/000271 discloses the addition of an insoluble gas to a drink in order to optimise the foaming properties of the drink and to give the drink a more pleasant and mild mouthfeel. Nevertheless WO 2008/000271 does not offer a solution for dispensing a drink with a high carbon dioxide content, such as beer that has been refermented in the barrel.

The aim of the present invention is to find a solution to the above problem of the prior art and proposes a tapping device which allows beers to be poured which have been refermented in the barrel and consequently have a high inherent CO₂ content.

### SUMMARY OF THE INVENTION

The invention relates to a device according to claim 1 and a system according to claim 9. The present invention allows drinks, such as beer refermented in the barrel, to be poured in a quality manner.

A following aspect of the invention relates to a method according to claim 11. The method allows beer, refermented in the barrel, to be poured without it foaming too much or becoming oversaturated.

### DESCRIPTION OF THE FIGURES

FIG. 1 shows one embodiment according to the present invention.

FIG. 2 shows results of a comparative test (from example 1) for dispensing a drink with a high carbon dioxide content by means of device comprising a tapping line with different dimensions.

### DETAILED DESCRIPTION

A first aspect of the invention relates to a device for dispensing a drink containing carbon dioxide, such as beer, from a barrel. In particular, the device according to the present invention must comprise the following components:
a tapping line which at a first end is connectable to a barrel, wherein a fluidic connection is created between the drink in the barrel and the tapping line:
a pressure line, also connectable to a barrel and connected to a source of compressed gas such as CO₂;
a cooling compartment for receiving one or more barrels, suitable for cooling the barrels at a determined temperature;
a tap tower provided with a faucet wherein the tap tower has an internal channel, wherein this internal channel is suitable for receiving part of the tapping line, including the second end of the tapping line. The tap tower is preferably provided with means of controlling (i.e. starting and stopping) the outflow of the beer. In one embodiment this can, for example, be a handle which can be manually placed in a flow or stop position by the user.

The present invention is characterised by the fact that the tapping line must meet specific definitive dimensions. In particular the tapping line must be of a length of between 1.8 and 2.4 m and have an internal diameter of between 2.5 and 3.5 mm. In particular the internal diameter must preferably be between 2.8 and 3.4 mm, even more preferably between 2.9 and 3.2 mm, such as 3 mm.

In a further preferred form the preferred length is between 1.9 and 2.3 m, such as 2 m.

In another embodiment the present invention relates to a device for dispensing a drink containing carbon dioxide, such as beer, from a barrel, wherein the device comprises the following components:
a tapping line which at a first end is connectable to a barrel, wherein a fluidic connection is created between the drink in the barrel and the tapping line:
a pressure line, also connectable to a barrel and connected to a source of compressed gas such as CO₂;
a cooling compartment for receiving one or more barrels, suitable for cooling the barrels at a determined temperature;
a tap tower provided with a faucet wherein the tap tower has an internal channel, wherein this internal channel is suitable for receiving part of the tapping line, including the second end of the tap wherein the length of the tapping line, (expressed in metres), relates to the CO₂ content of, the drink (expressed in grams per litre) in accordance with a factor of between 0.20 and 0.30 and wherein the internal diameter of the tapping line, (expressed in millimetres), relates to the CO₂ content of the drink (expressed in grams per litre) with a factor of between 0.25 and 0.5.

In both embodiments the tapping line is preferably made of a suitable polymer, such as ethylene-vinyl acetate, rubber, polypropylene or polyethylene.

The conditions relating to the diameter and the length of the tapping line have proven to be crucial for obtaining a quality poured draught beer that has been refermented in the barrel. The inventors have found that outside these ranges the quality of the tapped beer does not meet the predefined requirements (e.g. height of the head, density of the head, head stability and bubbling of the beer).

In particular the device must be suitable for dispensing a drink, such as beer or soft drinks with a carbon dioxide (CO₂) content of over 7 g/L in (in a closed barrel). This carbon dioxide content relates to both the natural content of CO₂ in the beer (through the fermentation and refermentation of sugars) as well as externally added CO₂. The dispensing of a liquid to such a high CO₂ content generally results in excessive foaming which is obviously not desirable.

In addition to the dimensions of the tapping line the inventors of the present invention have also found that the temperature of the beer in the barrel plays an important role in the dispensing of a quality drink such as beer. For this a cooling compartment, such as a barrel refrigerator, is provided which can contain one or more barrels of drink and can be cooled to a determined temperature by cooling means provided for this. In particular, the preferred temperature of the cooling compartment can be adjusted to a temperature of 3 to 5° C., preferably between 3.5° C. and 4.5° C. These temperature ranges are the preferred usage ranges for the dispensing of a liquid by means of a device according to the present invention. It is generally known that the solubility of CO₂ in a liquid is dependent on the temperature. The inventors of the present invention have found that for liquids with a high CO₂ content (higher than 7 g/l CO₂) a temperature range as described above is crucial for maintaining the CO₂ content for quality dispensing of the drink. A liquid such as beer which can be served cold can appear “flat” if the CO₂ remains dissolved in the beer.

At a correct temperature of the liquid no CO₂ relaxation should take place and the beer will not foam excessively. A preferred outflow temperature of the drink containing carbon dioxide is between 4° C. and 7° C., more preferably between 5 and 6.5° C., even more preferably between 5.8 and 6.2° C.

In particular, the cooling compartment must be suitable for receiving at least two barrels with a content of between 20 and 30 litres. Even more preferably the cooling compartment must be suitable for housing 4 barrels each containing 20 litres.

In a further embodiment the device according to the present invention can be provided with additional cooling means in the tap tower. In particular the present invention can contain cooling means internally in the tap tower. These cooling means can comprise a ventilator. This additional cooling ensures better ventilation of the cold air in the device and in the tap tower and consequently of the outflow temperature of the beer.

In another or further embodiment the present device is provided with means for regulating the pressure in a barrel. In particular the device is provided with a pressure line which can provide a pressure situated between 2 and 3 bars, more preferably between 2.2 and 2.5 bars, for example 2.3 bars. This pressure is provided by an externally connected reservoir of pressurised CO₂ and can be adjusted by means of a pressure regulator and read off by means of a manometer.

The pre-set pressure also appears to have a positive influence on the outflow behaviour of the drink with a high CO₂ content. At the pre-set pressure the CO₂ content of the drink is guaranteed as an equilibrium is brought about between the CO₂ content in the beer and the CO₂ supplied by the pressure line.

In a preferred form of the present invention both the temperature and the pressure are determined in the ranges as described above.

Both the tapping line and the pressure line should be connectable at one end to the barrel. In a preferred form the barrel is provided with a coupling piece which can be mounted on a barrel opening and connected to a tapping line and pressure line. In a further embodiment the coupling piece is provided with a valve system. In particular, the coupling piece can be selected from the group of an A coupling system, D coupling system, G coupling system, M coupling system, S coupling system or a U coupling system. In a preferred form use is made of an S coupling system.

In one embodiment according to the present invention the tapping line can be reused several times. In this case the tapping line should be cleaned after intensive use. This can take place by rinsing with water and/or a cleaning agent and/or by mechanical cleaning (for example by means of a sponge).

In an alternative embodiment the device is provided with a replaceable, single-use, tapping line. Such a tapping line must also be replaced every time the barrel is changed. This has the advantage that the line does not have to be cleaned which saves time and costs and beer loss. At the same time this “disposable” system is more hygienic than a system that has to be cleaned.

In particular a tapping line for single use must be replaceable via the faucet and tower. In particular the faucet must be at least partially openable which provides access to the internal channel of the tap tower along which the tapping line can be placed. A first end of the tapping line is provided with a coupling piece which can be connected to the coupling piece provided on the barrel. A second end of the tapping line is also provided with a coupling piece, wherein this second coupling piece is provided with an outflow element for the liquid and wherein the second coupling piece allows assembly in the faucet.

This device can also be provided with a rinsing tank, water tap, drip and/or tap tray depending on the embodiment of the device.

In a further embodiment of the present invention the device is mobile. For this the device can be provided with wheels which make the device moveable.

In a second aspect the present invention relates to an assembly wherein the assembly comprises a device in a form of an embodiment as described above, and a barrel of beer is connected to the device. Connection takes place by way of the tapping line and the pressure line. In particular, the beer has an internal CO₂ content which is greater than 7 g/L, preferably between 7 g/L and 9 g/L.

Even more particularly the beer must be refermented in the barrel. During the refermentation phase (typically a time scale of 7 to 21 days, preferably 14 days) the beer must contain 1 to 2 million live yeast cells per ml. In addition, at the start of the refermentation phase the beer must contain 0.1 to 0.8 degrees plato, preferably 0.1 to 0.5 degrees plato, most preferably 0.1 to 0.2 degrees plato of fermentable sugars, preferably glucose and fructose.

The barrel should preferably be made of stainless steel. Preferably the volume of the barrel should be 20 to 50 litres, more preferably it is a 20 or 30 litre barrel. In one possible embodiment, only one part of the maximum capacity of the barrel is used (for example it is only 90% filled with beer).

Because of the high internal CO₂ content of the beer the barrel must be able to withstand a high internal pressure. In particular, the barrels must be able to withstand a pressure of at least 3 bars, such as 3 to 10 bars, preferably at least 4 bars, such as 4 to 10 bars, more preferably at least 5 bars, such as 5 to 10 bars, even more preferably at least 6 bars, such as 6 to 10 bars, and most preferably at least 7 bars, such as 7 to 10 bars.

A third aspect of the invention relates to a method of tapping draught beer. In particular the beer must have an internal CO₂ of greater than or equal to 7 g/L and the method is characterised in that a tapping device is provided as described in one of the previous examples of embodiment wherein the tapping line is connectable to the barrel, has a length of between 1.8 and 2.4 m and has an internal diameter of between 2.5 and 3.5 mm.

The method is also characterised in that an external gas source is provided which supplies an external pressure of between 2 and 3 bars to the beer. Here the beer is cooled in a compartment of the device provided for this which is suitable for receiving the barrels, wherein the temperature is situated between 3.5 and 4.5° C.

In one embodiment the tapping line should be cleaned after intensive use. In another, more preferred, form the tapping line must be replaced each time a new barrel is brought into use. Preferably replacement of the tapping line should take place along the tap column and faucet.

In order to assure the quality of the beer a new barrel must be present in the cooling compartment at least 48 hours before use. This ensures that the beer has the correct temperature and that consequently no problems will occur during tapping.

The invention will now be explained by way of the examples and figures without being restricted thereto.

### DETAILED DESCRIPTION OF THE FIGURES

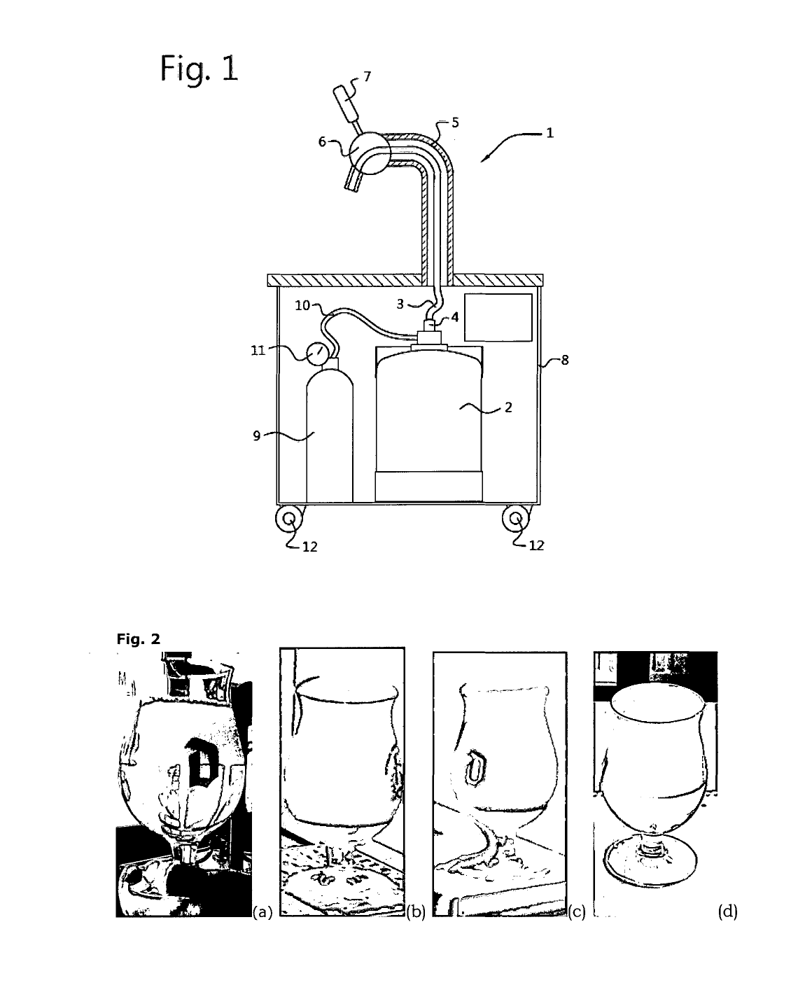

FIG. 1 shows a device (1) according to one embodiment of the present invention connected to a barrel of beer (2) that has been refermented in the barrel and which has an internal CO₂ of between 7 and 9 g/L. Connection of the barrel (2) to the device (1) takes place by means of a tapping line (3) which is attached to the barrel via a coupling piece (4) at the barrel opening and is in fluidic connection with the beer in the barrel. The tapping line (2) has very specific dimensions, wherein the length is 2 m and the internal diameter is 3 mm.

The tapping line (2) then runs via an internal channel of the tap tower (5) to the faucet (6) where the tapping line opens. At this end, the tapping line can also be provided with a second coupling piece, wherein the second coupling piece is provided with an outflow element for the beer (not shown in the drawing) and wherein the second coupling piece allows assembly in the faucet. The faucet (6) is preferably provided with a handle (7) which controls the tapping of the beer and the operation of the device. The tap tower (5) can internally be provided with a ventilator (not shown in the drawings) which ensures more optimum cooling of the beer during tapping.

The tap tower (5) is mounted on top of a compartment (8) suitable for receiving and storing one or more barrels. This compartment (8) is also provided with cooling means which ensure that the stored barrels are at a correct and desired temperature. For this the cooling compartment (8) is provided with temperature indicators and regulators. The temperature of the cooling compartment is preferably set to between 3 and 5° C.

The compartment (8) is also provided with a source of CO₂ gas (9) which is connected to the gas (2) via a pressure in line (10). A manometer (11) is provided for monitoring the supplied pressure, while a pressure regulator ensures that the correct pressure is delivered. The ideal pressure according to the present invention is between 2 and 3 bars.

Underneath (on the underside of the cooling compartment) the device can be provided with wheels (12) through which is comes mobile.

### EXAMPLES

The present invention will be described in more detail by way of the following non-limiting examples.

### Example 1: Comparative Test Relating the Dimensions of the Tapping Line

In four separate tapping sessions, beer was tapped from the barrel by means of a tapping device comprising a tapping line, a pressure line, a cooling compartment and a tap tower. Except for the dimensions of the tapping line the four tapping sessions were carried out under identical conditions:
in the first tapping session the tapping device comprised a tapping line with a length of 200 cm and an internal diameter of 3 mm;
in the second tapping session the tapping device comprised a tapping line with a length of 150 cm and an internal diameter of 4 mm;
in the third tapping session the tapping device comprised a tapping line with a length of 150 cm and an internal diameter of 3 mm; and
in the fourth tapping session the tapping device comprised a tapping line with a length of 180 cm and an internal diameter of 3 mm.

During each of the four tapping sessions beer was tapped from the barrel at 3.2° C. and at a pressure of 2.3 bar three times in identical glasses. The tapping of a glass of beer involves the filling of a glass by means of the tapping device until the beer, or head, reaches the upper edge of the glass. For each tapped glass of beer the following parameters were measured:
(i) time required for tapping one glass of beer; and
(ii) height of the head in a tapped glass of beer.

In addition—in a blind test set-up—the consumer and/or the tapper were asked to give a visual score of 1 to 5 on the basis of bubbling and the foam stability of the glass of tapped beer (where 1 is the lowest score and 5 is the highest score). The results of the relevant parameters are set out in table 1.

FIG. 2 shows results of a comparative test between three devices for dispensing a drink containing carbon dioxide, in particular beer, from example 2. In this a glass of beer is tapped by means of a device comprising a tapping line with (a) a length of 200 cm and an internal diameter of 3 mm; (b) a length of 150 cm and an internal diameter of 4 mm; (c) a length of 150 cm and internal diameter of 3 mm; and (d) a length of 180 cm and in internal diameter of 3 mm.

FIGS. 2a and 2d each show a glass of beer which has been tapped by means of a device according to the present invention, while FIGS. 2b and 2c each show a glass of beer that has been tapped by means of a tapping line which does not comply with the parameters according to the present invention. For each test the same beer was tapped under identical conditions.

From the results (set out in table 1 and FIG. 2) it can be seen that a tapping device with a tapping line according to the present invention allows a beer refermented in the barrel with a high CO₂ content to be poured in a substantially more qualitative manner than the same beer tapped by means of a tapping device which is not in accordance with the present invention. The dimensions of the tapping device are therefore important for the pouring of a quality beer.

TABLE 1
Results of comparative tests example 1. Draught beer is cooled
to 3.2° C. before the start of tapping, and beer is tapped
at a pressure of 2.3 bars during all tapping sessions.

| | Time required for | Height of | Visual |
|---|---|---|---|
| | tapping one glass | head | score |
| | of beer (s) | (cm) | (1-5) |
| Tap session 1 - tapping device | 13.3 | 6.1 | 4 |
| comprising tapping line | 12.8 | 7.2 | 4.5 |
| with: - I = 200 cm; and = | 13.6 | 5.6 | 4.5 |
| diameter = 3 mm | | | |
| Tap session 2 - tapping device | 4.3 | 9.0 | 1.5 |
| comprising tapping line | 4.3 | 9.1 | 1.5 |
| with: - I = 150 cm; and - | 4.2 | 9.4 | 2 |
| diameter = 4 mm | | | |
| Tap session 3 - tapping device | 7.0 | 1.9 | 2 |
| comprising tapping line | 6.8 | 2.3 | 2 |
| with: - I = 150 cm; and = | 7.1 | 2.2 | 1.5 |
| diameter = 3 mm | | | |
| Tap session 4 - tapping device | 9.4 | 8.6 | 2.5 |
| comprising tapping line | 12.4 | 7.4 | 4 |
| with: - I = 180 cm; and = | 12.4 | 6.6 | 4 |
| diameter = 3 mm | | | |

1. A device for dispensing a drink containing carbon dioxide, such as beer, from a barrel, the device comprising:
a tapping line with a first end and a second end which at the first end is connectable to a barrel containing the drink, wherein a fluidic connection is created between the drink in the barrel and the tapping line:
a pressure line that is connectable to a barrel and connected to a source of compressed air or gas;
a cooling compartment for one or more barrels;
a tap tower provided with a faucet wherein the tap tower has an internal channel for receiving part of the tapping line, including the second end, characterised in that a length of the tapping line is between 1.8 and 2.4 m and the tapping line has an internal diameter of between 2.5 and 3.5 mm.

2. The device according to claim 1 characterised in that the internal diameter of the tapping line is between 2.9 and 3.2 mm.

3. The device according to claim 2 characterised in that the internal diameter of the tapping line is between 2.2 and 2.4 mm.

4. A device for dispensing a drink containing carbon dioxide, such as beer, from a barrel, the device comprising:
a tapping line with a first end and a second end which at the first end is connectable to a barrel containing the drink, wherein a fluidic connection is created between the drink in the barrel and the tapping line:
a pressure line that is connectable to a barrel and connected to a source or compressed air or gas;
a cooling compartment for one or more barrels;
a tap tower provided with a faucet wherein the tap tower has an internal channel for receiving part of the tapping line, including the second end, characterised in that the length of the tapping line, expressed in metres, relates to the CO₂ content of the drink, expressed in grams per litre, in the barrel to be connected in accordance with a factor of between 0.25 and 0.35 and wherein the internal diameter of the tapping line, expressed in millimetres, relates to the CO₂ content of the drink, expressed in grams per litre, in the barrel to be connected with a factor of between 0.25 and 0.5.

5. The device according to claim 4 characterised in that the cooling compartment has an adjustable temperature, wherein the temperature is between 3 and 5° C.

6. The device according to claim 4 characterised in that the pressure line is provided with a pressure of between 2 and 3 bars.

7. The device according to claim 4 characterised in that the tapping line is replaceable via the faucet.

8. The device according to claim 4 characterised in that a coupling piece is provided which is mounted on a barrel opening and connected to the tapping line and the pressure line.

9. An assembly comprising a device according to claim 1, and a barrel of beer connected to the device by the tapping line and the pressure line, characterised in that that the beer has an internal CO₂ content that is greater than 7 g/L.

10. The assembly according to claim 9 characterised in that the beer has been refermented in the barrel.

11. A method of tapping draught beer, wherein the beer has a CO₂ content of greater than 7 g/L, characterised in that a tapping device is provided with which the tapping line, connectable to the barrel, has a length of between 1.8 and 2.4 m and has an internal diameter of between 2.5 and 3.5 mm.

12. The method according to claim 11 characterised in that an external gas source is provided which supplies an external pressure of between 2 and 3 bars to the beer.

13. The method according to claim 11 characterised in that the beer is cooled in a compartment of the device suitable for receiving the barrel, wherein the temperatures is situated between 3 and 5° C.

14. The method according to claim 11 characterised in that the tapping line is replaced each time a new barrel is brought into use.

15. The method according to claim 11 characterised in that a new barrel is present in the cooling compartment at least 48 hours before use.

16. An assembly comprising a device according to claim 4, and a barrel of beer connected to the device by the tapping line and the pressure line, characterised in that that the beer has an internal CO₂ content that is greater than 7 g/L.

17. The assembly according to claim 16 characterised in that the beer has been refermented in the barrel.

18. The assembly of claim 9, wherein the internal CO₂ content that is between 7 g/L and 9 g/L.

19. The assembly of claim 16, wherein the internal CO₂ content that is between 7 g/L and 9 g/L.
